(19) United States
(12) Patent Application Publication
(10) Pub. No.: US 2011/0133994 A1
(43) Pub. Date: Jun. 9, 2011

(54) INTERNAL MULTI-BAND ANTENNA AND METHODS

(76) Inventor: Heikki Korva, Tupos (FI)

(21) Appl. No.: 12/672,665

(22) PCT Filed: Nov. 8, 2007
(86) PCT No.: PCT/FI2007/050600

§ 371 Date: Feb. 17, 2011

(30) Foreign Application Priority Data
Nov. 15, 2006 (FI) 20065728

(51) Int. Cl. H01Q 1/24; H01Q 1/48

(52) U.S. Cl. 343/702; 343/745

(57) ABSTRACT

An internal multi-band antenna and a radio device comprising such an antenna. A radiator (320) of the antenna is a conductivepart of the outer cover (COV) of a radio device or conductive coating of the cover. The radiator is electromagnetically fed by a feed element (330) which is isolated from the radiator by a relatively thin dielectric layer. The feed element is shaped so that it has, together with the other parts of the antenna, resonance frequencies in the range of at least two desired operating bands. The antenna structure further includes a parasitic tuning element (340) and a switch (SW) by which the tuning element can be coupled to the signal ground (GND) through at least two alternative reactive circuits. The tuning element is dimensioned and placed and the component values of the reactive circuits are chosen so that of two operating bands of the antenna the locations of both are displaced in a desired way when changing the state of the switch. By means of a relatively simple switch arrangement, the antenna can be made to cover the frequency ranges of four systems, and it can also be optimised for each system separately, because its operating bands only cover the range used by one system at a time.

The invention relates to an internal multi-band antenna intended for small-sized radio devices. The invention also relates to a radio device with an antenna according to it.

In portable radio devices, especially mobile stations, the antenna is most preferably placed inside the device for convenience of use. The internal antenna of a small-sized device is usually of planar type, because the antenna is then most easily obtained satisfactory of its electric characteristics. The planar antenna includes a radiating plane and a ground plane parallel with it. In order to facilitate the impedance matching, the radiating plane and the ground plane are usually connected to each other at a suitable point by a short-circuit conductor, in which case a PIFA (planar inverted F-antenna) is made up.

For saving space in a small-sized radio device, a part of its outer cover can be made conductive and used as the radiating plane of the antenna. Furthermore, the radiator being in the cover of the device, the radiation characteristics of the antenna are improved compared to an inner-located radiator. On the other hand, the shaping of the radiator is limited, which impedes obtaining desired electric characteristics. This disadvantage can be reduced by using a separate feed element between the radiator and the ground plane.

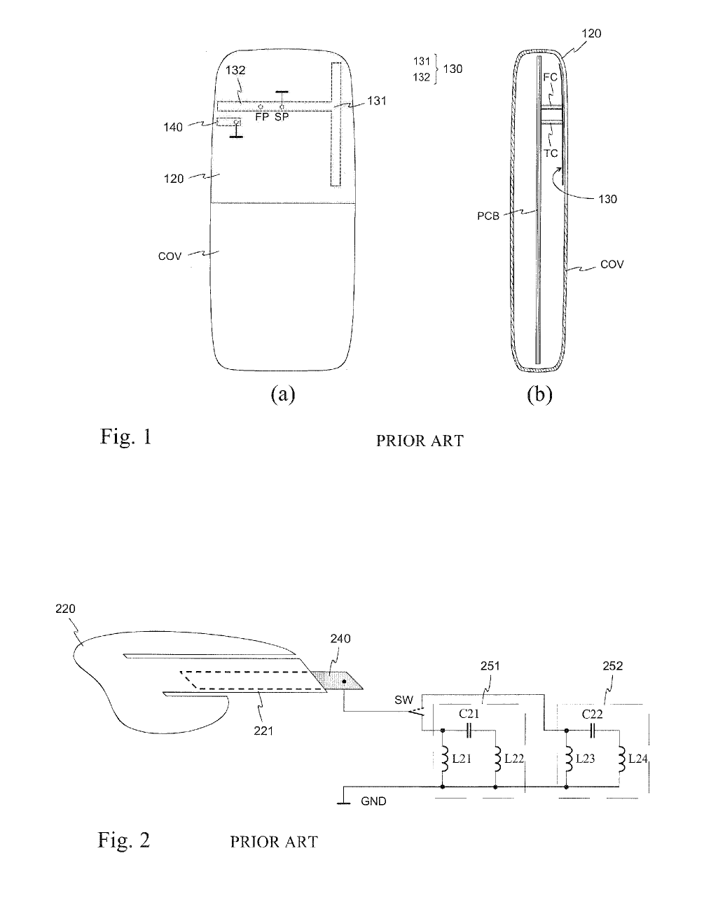

FIG. 1 shows an example of an antenna, known from publication EP1439601, in which the radiator is a part of the outer cover of the radio device and it is fed by a separate feed element. In the sub-drawing (a) the radio device is presented from behind and in the sub-drawing (b) from the side as a simplified longitudinal section. The upper part 120 of the rear part of the outer cover COV of the device is of conductive material and functions then as the radiating element. Against the inner surface of the radiating element 120, there is a thin and flexible dielectric substrate on the inner surface of which there is the feed element 130. The sub-drawing (a) shows the feed element as a dotted line and the sub-drawing (b) as a line following the outer cover. In this example, the feed element is a conductor strip resembling a letter T about in the middle of the stem part of which there are the feed point FP and the short-circuit point SP of the antenna. The feed point is connected to the antenna port on the circuit board PCB of the radio device by the feed conductor FC, and the short-circuit point is connected to the ground plane as well on the circuit board of the radio device. This ground connection is seen as a graphic symbol in the sub-drawing (a). The short-circuit point SP divides the feed element 130 into two parts. Its first part 131 consists of one portion of said stem part and a transverse strip joining its end. The second part 132 of the feed element consists of the other portion of the stem part. The antenna has two bands: the first part of the feed element together with the radiator and the ground plane resonates in the lower operating band and the second part together with the radiator and the ground plane resonates in the upper operating band.

On the inner surface of said substrate there is, in addition to the feed element 130, a parasitic tuning element 140 which is a relatively small conductor strip close to the second part 132 of the feed element. The tuning element is galvanically coupled to the ground plane by its own short-circuit conductor TC. By means of it, in this structure, the resonance frequency dependent primarily on the radiating element 120 and the ground plane is tuned so that also this frequency can be utilised in the antenna. Naturally, the tuning element affects also a little the frequencies of the above-mentioned resonances, primarily dependent on the feed element.

In an antenna according to FIG. 1, there is no need for the radiator to be of specific size; it can be advantageously made relatively large. Furthermore, the radiator can be fitted by shape freely to the radio device. The matching of the antenna takes place by means of the shaping and the short circuit of the feed element. The antenna is space-saving also because the distance between the ground plane and the feed element can be, because of the relatively large radiator, left somewhat smaller than the distance between the ground plane and the radiating plane of a corresponding ordinary PIFA. However, a disadvantage is that the operating bands, especially the lower one, are relatively narrow. From this follows that if the device was to function e.g. in both European and American GSM systems (Global System for Mobile communications), the characteristics of the antenna would not be adequate.

The disadvantage caused by the narrow operating band can be reduced by displacing the operating band to a required range each time. The displacement can take place so that the electric size of the antenna or one of its parts is changed by altering the impedance included in the structure by means of a switch. FIG. 2 shows an example of such a solution known from publication EP1544943. The antenna of the example is a PIFA with two bands, of the basic structure of which only a part of a radiating plane 220 is drawn visible. The antenna comprises, in addition to the basic structure, an adjusting circuit which includes a parasitic element 240 of the radiating plane, a two-way switch SW and a first 251 and a second 252 reactive circuit. The parasitic element is in this example a conductor strip located below a part 221 of the radiating plane corresponding to the upper operating band of the antenna. The parasitic element is fixedly connected to the common terminal of the two-way switch. One of the change terminals of the switch is fixedly coupled to the first terminal of the first reactive circuit 251 and the other to a first terminal of the second reactive circuit 252. The second terminals of both reactive circuits again are fixedly connected to the signal ground GND. Thus, depending on the state of the switch SW, either of the reactive circuits at a time is connected between the parasitic element 240 and the signal ground. Here, the first reactive circuit 251 consists of a parallel circuit one branch of which is a coil L21 and the other branch of which is a capasitor C21 and a coil L22 in series. Such a reactive circuit is at low frequencies inductive, in an intermediate range capacitive and upwards from that again inductive. At the lower boundary of the intermediate range, the reactive circuit has a parallel resonance, in which case its absolute value is very high, and at the upper boundary, a serial resonance, in which case its absolute value is very low. By structure, the second reactive circuit 252 is similar to the first one: there is a coil L23 and parallel to it a serial circuit of a capasitor C22 and a coil L24. The circuit values are chosen so that both reactive circuits have the serial resonance in the intermediate range of the lower and the upper operating band of the antenna but at different points. Then when changing the state of the switch, the inductive reactance existing from the part 221 of the radiating plane through the parasitic element to the ground alters. For this reason, also the electric length and the corresponding resonance frequency of the part corresponding to the upper operating band, measured from the short-circuit point of the radiating plane, alter. The circuit values are further chosen so that desired alternative locations are obtained for the upper operating band. The lower operating band stays in this example in its place, because the absolute value of both reactive circuits is very high at its frequencies. By changing the circuit values, it is naturally possible to alternatively arrange a desired displacement for the lower operating band.

The antenna according to FIG. 2 has not been designed to use a separate feed element nor has it been predicted to take into consideration possibilities provided by such.

The object of the invention is to implement a multi-band antenna with a novel, more advantageous way compared to prior art. The antenna according to the invention is characterised by what is presented in the independent claim 1. Some advantageous embodiments of the invention are presented in the other claims.

The basic idea of the invention is the following: The radiator of the antenna is a conductive part of the outer cover of a radio device or conductive coating of the cover. The radiator is electromagnetically fed by a feed element which is isolated from the radiator by a relatively thin dielectric layer. The feed element is shaped so that it has, together with the other parts of the antenna, resonance frequencies in the range of at least two desired operating bands. The antenna structure further includes a parasitic tuning element and a switch by which the tuning element can be coupled to the signal ground through at least two alternative reactive circuits. The tuning element is dimensioned and placed and the component values of the reactive circuits are chosen so that of two operating bands of the antenna the locations of both are displaced in a desired way when changing the state of the switch.

An advantage of the invention is that by means of a relatively simple switch arrangement, the antenna can be made to cover the frequency ranges used by four systems. The antenna can also be optimised for each system separately, because its operating bands cover only the range used by one system at a time. A further advantage of the invention is that the element, which is shaped based on the desired appearance of the device, can be used as the radiator of a multi-band antenna. Both arranging the locations of the operating bands and matching of the antenna can be implemented without shaping the radiator element because of them. Furthermore, advantages of the invention are that the space required by the antenna inside the device is relatively small and, the radiating element being in the cover of the device, the radiation characteristics of the antenna are improved compared to an inner-located radiator.

The invention will now be described in detail. The description refers to the accompanying drawings in which

FIG. 1 shows an example of the internal multi-band antenna according to prior art,

FIG. 2 shows a second example of the internal multi-band antenna according to prior art,

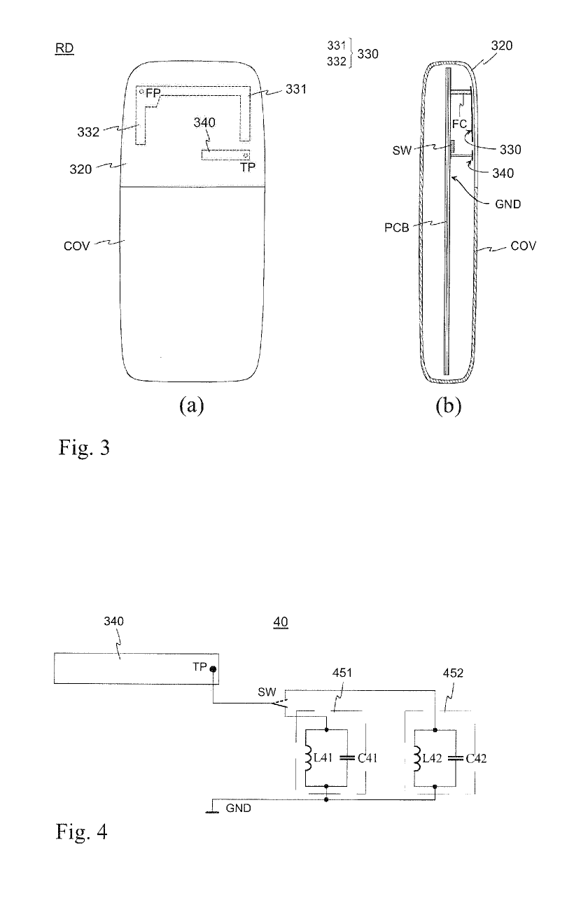

FIG. 3 shows an example of the internal multi-band antenna according to the invention,

FIG. 4 shows an example of the tuning circuit of an antenna according to FIG. 3,

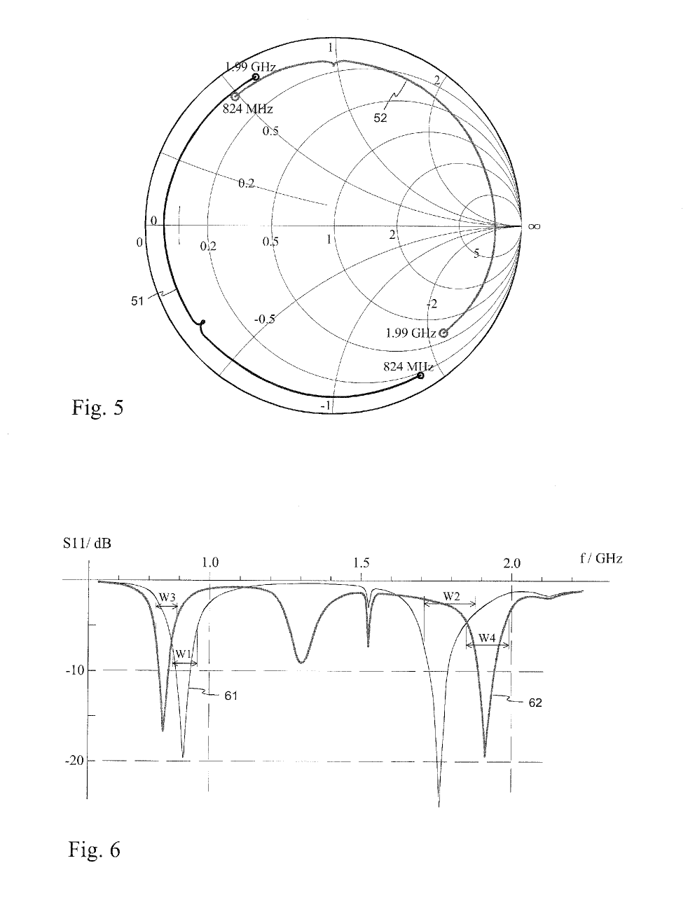

FIG. 5 shows as a Smith diagram an example of the impedance variations of the tuning circuit of an antenna according to the invention,

FIG. 6 shows an example of the displacement of the operating bands of an antenna according to the invention, and

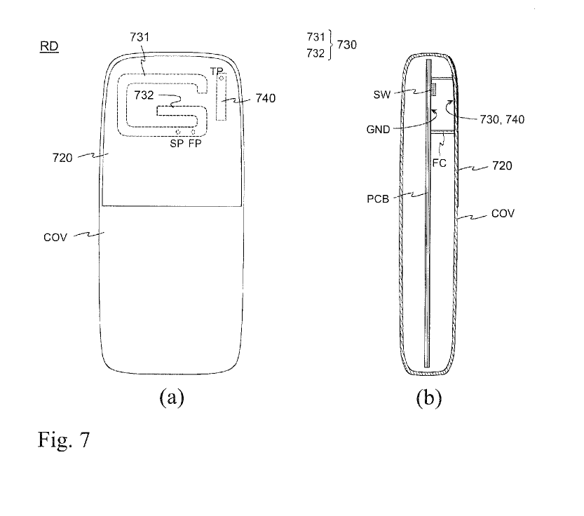

FIG. 7 shows a second example of the internal multi-band antenna according to the invention.

FIGS. 1 and 2 were already discussed in connection with the description of prior art.

FIG. 3 shows an example of an internal multi-band antenna of a radio device according to the invention. In the sub-drawing (a) the radio device is presented from behind and in the sub-drawing (b) from the side as a simplified longitudinal section. The upper part 320 of the rear part of an outer cover COV of the device is of conductive material and functions thus as a radiating element, as in FIG. 1. The radiating element, or the radiator, is electromagnetically fed by a separate feed element 330 which is a conductor strip on the surface of a thin and flexible dielectric substrate. One side of the substrate is against the inner surface of the radiator. The sub-drawing (a) shows the feed element 330 as a dotted line and the sub-drawing (b) as a line following the outer cover. The feed element resembles a wide rectangular letter U in this example. Its middle portion is relatively close to the end of the radio device to which the radiator extends, and the parallel side portions are directed from the ends of the middle portion towards the opposite end of the device. The feed point FP of the antenna is in one corner point of the feed element from which it is coupled to the antenna port on the circuit board PCB of the radio device by a feed conductor FC. In the corner point in question, there is conductive surface on a wider area than in the other corner point. Because of its location, the feed point FP divides the feed element 330 into two parts of different lengths. Its first part 331 consists of said middle portion and the first side portion, and the second part 332 consists solely of the second side portion. The antenna has two bands: the first part 331 of the feed element together with the antenna's other parts resonates in the lower operating band and the second part 332 together with the antenna's other parts resonates in the upper operating band. Said other parts of the antenna include the ground plane which is a relatively unitary conductive coating of the circuit board PCB.

On the surface of said substrate, there is in addition to the feed element 330 a parasitic tuning element 340. It is in this example a conductor strip parallel to the middle portion of the feed element being locates, seen from the feed point FP, relatively close to the diagonally opposite corner of the radiator. At one end of the tuning element 340 relatively close to the end of the feed element on the side of the first side portion, there is the tuning point TP from which the tuning element can be coupled to the ground plane through alternative reactive circuits. The reactive circuits and the switch SW used in the circuit are located on the circuit board PCB of the radio device, where the switch is also drawn in sight in sub-drawing (b).

According to the description above, the antenna in FIG. 3 differs from the known antenna in FIG. 1 so that the parasitic element is now not connected directly to the ground, and the shaping of the feed element and the locations of the elements differ from the ones in FIG. 1. Furthermore, in the example of FIG. 3, the feed element has no short-circuit point and conductor. Instead, the antenna matching can be optimised by a coil placed on the circuit board PCB, connected between the feed conductor FC and the ground.

The antenna according to FIG. 3 has the same general advantages as the one according to FIG. 1. In other words, there is no need for its radiator to be of specific size and it can thus be advantageously made also relatively large. Furthermore, the radiator can be fitted by shape freely to the radio device. The electric matching of the antenna mainly takes place by means of the shaping of the feed element and the tuning element, which, for its part, gives freedom to shape the radiator. The antenna is space-saving because of the location of the radiator and because the distance between the ground plane and the feed element can be made relatively small. In addition, both operating bands of a dual-band antenna can be displaced, using one switch, in a desired way from the range of one radio system to the range of another radio system. This will be described more precisely in the following.

FIG. 4 shows an example of the tuning circuit of an antenna according to FIG. 3. An adjusting circuit 40 includes a two-way switch, or an SPDT (single-pole double through) switch SW and a first 451 and a second 452 reactive circuit. Also the tuning element 340 of the antenna seen in FIG. 3 can be considered to be included in the tuning circuit. The tuning point TP of the element 340 is connected to the common terminal of the two-way switch. One of the change terminals of the switch is connected to the first terminal of the first reactive circuit and the other to the first terminal of the second reactive circuit. The second terminals of both reactive circuits are again connected to the ground. Thus, depending on the state of the switch SW, either of the reactive circuits at a time is connected between the tuning element and the ground. The first reactive circuit 451 consists of the parallel circuit of a coil L41 and a capacitor C41 and the second reactive circuit 452 of the parallel circuit of a second coil L42 and a second capacitor C42. The absolute value of the impedance of such a reactive circuit is, as known, high at the resonance frequency of the circuit and relatively close to it.

The implementation way of the switch SW is a semiconductor component manufactured with e.g. FET (Field Effect Transistor) or PHEMT (Pseudomorphic High Electron Mobility Transistor) technique or a switch of MEMS (Micro Electro Mechanical System) type.

FIG. 5 shows as a Smith diagram an example of the impedance variations of the tuning circuit of an antenna according to the invention. The example relates to the tuning circuit according to FIG. 4 in which L41=27 nH, C41=1.3 pF, L42=1.5 nH, and C42=1.0 pF. The shapings and locations of the feed and tuning elements are according to FIG. 3. Curve 51 shows the variation of the impedance of the tuning circuit as a function of frequency, when the tuning element is connected to the first reactive circuit, and curve 52 shows the variation of the impedance, when the tuning element is connected to the second reactive circuit. In a lossless case, the curves would follow the outer circle of the diagram. Now they travel only relatively close to the outer circle, which means losses of certain amount in the tuning circuit.

In both curves, the head portion, i.e. the portion starting from the point corresponding to the frequency of 824 MHz in the diagram, represents the lower operating band of the antenna, in which there are the frequency ranges used by the GSM850 and GSM900 systems. The tail portion of both curves, i.e. the portion finishing to a point corresponding to the frequency of 1.99 MHz in the diagram, represents the upper operating band of the antenna in which there are the frequency ranges used by the GSM1800 and GSM1900 systems.

When the first reactive circuit has been chosen, the impedance of the tuning circuit is capacitive in the lower operating band and its absolute value is in the range of about (60-80)Ω, when the nominal impedance of the antenna is 50Ω. In the upper operating band the impedance is inductive and its absolute value is in the range of about (10-25)Ω. When the second reactive circuit has been chosen, the impedance of the tuning circuit is inductive in the lower operating band and its absolute value is in the range of about (10-35)Ω. In the upper operating band, the impedance is capacitive and its absolute value is in the range of about (150-500)Ω. Regarding the lower operating band the impedance alters from capacitive to inductive and, regarding the upper operating band, from inductive to capacitive, when the first reactive circuit is replaced by the second reactive circuit. From this follows that the electric length of the whole antenna increases in the lower operating band and decreases in the upper operating band. This further means that the lower operating band is displaced downwards and the upper operating band upwards.

FIG. 6 shows an example of the displacement of the operating bands of an antenna according to the invention. In the figure there is the reflection coefficient S11 as a function of frequency measured from the same antenna as the impedance curves in FIG. 5. Curve 61 shows the variation of the reflection coefficient, when the tuning element is connected to the first reactive circuit, and curve 62 shows the variation of the reflection coefficient, when the tuning element is connected to the second reactive circuit. In the former case, the lower resonance frequency of the antenna is about 915 MHz and the upper resonance frequency about 1.77 GHz. It is seen from the values of the reflection coefficient that the antenna functions satisfactorily in the frequency range 880-960 MHZ (W1 in the figure) used by the EGSM (Extended GSM) system and in the frequency range 1710-1880 MHz (W2 in the figure) used by the GSM1800 system. When the state of the switch is changed so that the tuning element is connected to the second reactive circuit, the lower resonance frequency of the antenna decreases to the value of about 850 MHz and the upper resonance frequency increases to the value of about 1.91 GHz. From the values of the reflection coefficient is seen that now the antenna functions satisfactorily in the frequency range 824-894 MHZ (W3 in the figure) used by the GSM850 system and in the frequency range 1850-1990 MHz (W4 in the figure) used by the GSM1900 system. The former systems EGSM and GSM1800 are in use in Europe, and the latter systems GSM850 and GSM1900 in America. The ability of the antenna to function when transferring over the Atlantic is thus worked out by one state change of the switch. The amounts and directions of the displacements of the operating bands are obtained correct by choosing the component values of the reactive circuits suitably and by arranging the strength of the coupling of the tuning element to the other antenna structure suitable. For example, related to the above-described example, in one state of the switch the antenna can function in the GSM850 and GSM1800 systems and in the other state of the switch in the EGSM and GSM1900 systems.

FIG. 7 shows a second example of the internal multi-band antenna of a radio device according to the invention. In the sub-drawing (a) the radio device is presented from behind and in the sub-drawing (b) from the side as a simplified longitudinal section. The rear part of the dielectric outer cover COV of the device is partly coated with conductive material, which functions as a radiating element 720 of the antenna. The radiator is electromagnetically fed by a separate feed element 730 which is a conductor strip on the inner surface of that area of the outer cover, which is covered by the radiator. Thus the cover forms the galvanic isolation between the feed element and the radiator. The feed element 730 is presented as a dotted line in the sub-drawing (a). It includes in this example, in addition to the feed point FP of the antenna, a short-circuit point SP from which it is connected to the ground plane GND on the circuit board PCB of the radio device. The feed and short-circuit point are relatively close to each other and they divide the feed element 730 into two parts of different lengths. Its first part 731 forms an open circle pattern and the second part 732 is directed to the inner area of that circle. The antenna has two bands: the first part of the feed element together with the other parts of the antenna resonate in the lower operating band and the second part together with the other parts of the antenna resonate in the upper operating band.

On the inner surface of the outer cover COV there is, in addition to the feed element, a parasitic tuning element 740. It is in this example beside the circle pattern formed by the feed element, the tuning point TP relatively close to the tail end of the first part 731 of the feed element. The tuning element is directed from the tuning point towards the continuation of the side of the feed element on which side the feed point FP and the short-circuit point SP are. Also in this case, the tuning element is connected to a switch SW on the circuit board PCB by means of which it can be coupled to one of the alternative reactances.

The outer surface of the radiating element 720 is naturally coated with a thin non-conductive protective layer.

The term “internal antenna” means in this specification and claims an antenna which does not change the appearance determined by the outer cover of a radio device. In the antenna according to the invention, the shapes and locations of the antenna elements can naturally differ from the ones described above. The switch of the tuning circuit can be a multi-way SPnT (single-pole n through) switch for coupling several alternative reactive circuits. The structure and the component number of the reactive circuits can differ from described. For example, at least one of them can be other than a parallel resonance circuit. However, they generally comprise an inductive and a capacitive part. The inductive part(s) can be implemented, besides a discrete coil, also by a conductor strip on the surface of the circuit board and the capacitive part(s) can be implemented, besides a discrete condenser, also by a conductor strip and a ground plane on the opposite surfaces of the circuit board. The invention does not limit the manufacturing technique of the antenna. The separate substrate between the feed element and the radiator can be of circuit-board material or other dielectric material. The antenna elements can be of some conductive coating, such as copper or conducting ink. They can also be of sheet metal or foil metal which is fastened e.g. by ultrasonic welding, stamping, gluing or with tapes. Different planar elements can have a different manufacturing and fastening way. The inventive idea can be applied in different ways within the limitations set by the independent claim 1.

1.-12. (canceled)

13. A multi-band antenna, comprising:
a radiating element;
a feed element; and
a tuning element;
wherein the tuning element is electrically coupled to a ground via a plurality of alternative reactive circuits.

14. The multi-band antenna of claim 13, wherein the feed element and the tuning element are galvanically isolated from the radiating element via a dielectric layer.

15. The multi-band antenna of claim 14, wherein the feed element and the dielectric layer are comprised of a flexible substrate.

16. The multi-band antenna of claim 13, further comprising:
a printed circuit board substrate comprising a switch;
wherein the ground and the plurality of alternative reactive circuits are disposed at least partly on said printed circuit board substrate.

17. The multi-band antenna of claim 13, further comprising a feed point electrically coupled to said feed element, said feed element comprising an upper operating band portion and a lower operating band portion.

18. The multi-band antenna of claim 17, wherein the lower operating band portion comprises a first conductor strip that extends in at least two directions; and
wherein the upper operating band portion comprises a second conductor strip that extends in at least one direction.

19. The multi-band antenna of claim 18, wherein the first and second conductor strips collectively comprise a substantially U-shaped conductor strip.

20. The multi-band antenna of claim 19, wherein the feed point resides in a corner portion of said substantially U-shaped conductor strip, said corner portion comprising a wider conductive area then an opposing corner of said substantially U-shaped conductor strip.

21. The multi-band antenna of claim 13, wherein at least two of the alternative reactive circuits each comprise an inductive portion and a capacitive portion disposed in parallel with respect to one another.

22. A radio device, comprising:
an external cover, said external cover comprised of a conductive radiating portion;
an internal circuit board substrate comprised of a ground plane;
a feed element; and
a tuning element;
wherein the feed element and the tuning element are each disposed proximate said external cover and are each electrically coupled to the internal circuit board substrate.

23. The radio device of claim 22, wherein the feed element and the tuning element are each galvanically isolated from the conductive radiating portion via a dielectric layer.

24. The radio device of claim 23, wherein the feed element, the tuning element and the dielectric layer are comprised of a flexible substrate.

25. The radio device of claim 22, wherein the feed element and the tuning element are each electrically coupled to the internal circuit board substrate via a feed conductor and a tuning conductor, respectively.

26. The radio device of claim 22, wherein the internal circuit board further comprises a switch and a plurality of alternative reactive circuits coupled to said switch.

27. The radio device of claim 26, wherein the switch in combination with at least the alternative reactive circuits changes the operating frequency bands of the radio device.

28. The radio device of claim 27, wherein a first of the operating frequency bands is for the EGSM system and the GSM1800 system and a second of the operating frequency bands is for the GSM850 system and the GSM1900 system.

29. An internal multi-band antenna of a radio device, comprising at least a lower and an upper operating band and further comprising:
a ground plane;
a radiating element;
a feed element; and
a parasitic tuning element;
wherein the radiating element follows an outer surface of the radio device and is galvanically isolated from the feed element and the tuning element by a relatively thin dielectric layer in which there is an electromagnetic coupling between the radiating element and the feed element to transfer transmitting energy to the field of the radiating element and to transfer receiving energy to the field of the feed element, said feed element comprising a conductor strip comprised of a feed point of the antenna and a first part which together with other parts of the antenna is arranged to resonate in the range of the lower operating band of the antenna; and
wherein a second part of the antenna is arranged to resonate in the range of the upper band of the antenna such that the tuning element belongs to a tuning circuit which further comprises a multi-way switch and at least two reactive circuits so that the tuning element can be connected from its tuning point to the signal ground through the switch and through one reactive circuit at a time to implement at least two alternative locations for both the lower and the upper operating band.

30. The multi-band antenna of claim 29, wherein at least one of the reactive circuits comprises a parallel circuit that includes an inductive part and a capacitive part.

31. The multi-band antenna of claim 30, wherein said inductive part comprises a discrete coil and said capacitive part comprises a discrete capacitor.

32. The multi-band antenna of claim 30, wherein said inductive part comprises a first conductor strip on a surface of a circuit board and said capacitive part comprises a second conductor strip on a surface of the circuit board and the ground plane.

33. The multi-band antenna of claim 29, wherein the second part of the feed element starts from the feed point and extends in a certain direction and the first part starts from the feed point to a substantially perpendicular direction with respect to the second part and makes a bend so that the shape of the feed element resembles a wide letter U, the tuning point of the tuning element is located relatively close to the tail end of the first part, and the tuning element is a substantially straight conductor strip which starts from the tuning point substantially parallel to a middle portion of the feed element towards the side of the second part of the feed element.

34. The multi-band antenna of claim 29, wherein said feed point is the sole point of the feed element from which it is coupled to the radio device.

35. The multi-band antenna of claim 29, wherein the feed element further comprises a short-circuit point from which it is galvanically coupled to the ground plane.

36. The multi-band antenna of claim 29, wherein the radiating element comprises a conductive part of an outer cover of the radio device and said dielectric layer is fastened to inner surface of the radiating element, the feed element and the tuning element residing on inner surface of the dielectric layer.

37. The multi-band antenna of claim 29, wherein the radiating element comprises a conductive coating of a dielectric outer cover of the radio device and the feed element and the tuning element are on inner surface of this dielectric outer cover, said dielectric layer then being a part of the dielectric outer cover at the radiating element.

38. The multi-band antenna of claim 29, wherein when the switch is in one state, said lower operating band covers the frequency range used by an EGSM system and said upper operating band covers the frequency range used by a GSM1800 system, and when the switch is in the other state, the lower operating band covers the frequency range used by a GSM850 system and the upper operating band covers the frequency range used by a GSM1900 system.

39. The multi-band antenna of claim 29, wherein the switch is selected from the group consisting of:
a FET switch;
a PHEMT switch; and
a MEMS type switch.

40. A method of operating multi-band antenna, the antenna comprising a radiating element, a feed element, and a tuning element, the method comprising:
electrically coupling the tuning element to a ground via a first of a plurality of reactive circuits; and
electrically coupling the tuning element to a ground via a second of a plurality of reactive circuits;
wherein the first and second reactive circuits cause the antenna to operate in first and second frequency bands, respectively.

41. The method of claim 40, further comprising galvanically isolating the feed element and the tuning element from the radiating element via a dielectric layer.

42. The method of claim 40, wherein the antenna further comprises a feed point electrically coupled to said feed element, said feed element comprising an upper operating band portion and a lower operating band portion, and the method further comprises operating the antenna through one of the lower operating band portion and the upper operating band portion.
